(19) United States
(12) Patent Application Publication
(10) Pub. No.: US 2010/0280778 A1
(43) Pub. Date: Nov. 4, 2010

(54) ELECTROMAGNETIC DISTRIBUTION PROCESSING DEVICE AND METHOD

(75) Inventor: Eiji OHTA, Kawasaki (JP)

Correspondence Address: KRATZ, QUINTOS & HANSON, LLP, 1420 K Street, N.W., 4th Floor, WASHINGTON, DC, 20005, US

(73) Assignee: FUJITSU LIMITED, Kawasaki (JP)

(21) Appl. No.: 12/759,953

(22) Filed: Apr. 14, 2010

(30) Foreign Application Priority Data
Apr. 30, 2009 (JP) 2009-110515

(51) Int. Cl. G06F 19/00; G06F 17/30

(52) U.S. Cl. 702/66; 707/803; 707/E17.044

(57) ABSTRACT

An electromagnetic distribution processing device calculates an electromagnetic distribution over areas that are spatially discretized. The electromagnetic distribution processing device includes an electromagnetic processing unit configured to calculate a physical amount of an electromagnetic current in each of the areas based on an electromagnetic field intensity; an electromagnetic change amount processing unit configured to calculate, for each of the areas, a temporal change amount of the physical amount of the electromagnetic current calculated by the electromagnetic processing unit; and a cumulative change amount processing unit configured to calculate, for each of the areas, a cumulative value that is obtained by accumulating the temporal change amounts of the physical amount of the electromagnetic current calculated by the electromagnetic change amount processing unit.

### CROSS-REFERENCE TO RELATED APPLICATIONS

This patent application is based upon and claims the benefit of priority of the prior Japanese Patent Application No. 2009-110515 filed on Apr. 30, 2009, the entire contents of which are incorporated herein by reference.

### FIELD

The embodiments discussed herein are related to an electromagnetic current distribution processing device.

### BACKGROUND

In recent years and continuing, electronic devices are becoming increasingly high-performance and high-speed. Accordingly, printed circuit boards included in the electronic devices are becoming miniaturized and dense. Furthermore, the shapes of cables, connectors, plates, and antennas of the electronic devices are becoming increasingly complex.

For example, on a printed circuit board, a large amount of information is processed within a short period of time. Therefore, high-speed signals of high frequency (i.e., short period) are propagated to the printed circuit board. Furthermore, as circuit designs are becoming complex, there are cases where an appropriate GND surface is not provided immediately under the wires used for transmission. As a result, the characteristic impedance of the wires deviates from the designed value, and the currents of the high-speed signals may divert along an unexpected route.

Consequently, the signal waveforms become significantly deformed, and the signals are not properly propagated, which may cause errors in the electronic device.

Thus, at the stage of designing an electronic device, it is important to accurately identify the propagation paths of the signals when configuring the wires used for transmitting high-speed signals (see, for example, Japanese Laid-Open Patent Application No. H6-266787 and Japanese Laid-Open Patent Application No. 2002-231813).

### SUMMARY

According to an aspect of the invention, an electromagnetic distribution processing device calculates an electromagnetic distribution over areas that are spatially discretized (segmented into spatially discrete parts). The electromagnetic distribution processing device includes an electromagnetic processing unit configured to calculate a physical amount of an electromagnetic current in each of the areas based on an electromagnetic field intensity; an electromagnetic change amount processing unit configured to calculate, for each of the areas, a temporal change amount of the physical amount of the electromagnetic current calculated by the electromagnetic processing unit; and a cumulative change amount processing unit configured to calculate, for each of the areas, a cumulative value that is obtained by accumulating the temporal change amounts of the physical amount of the electromagnetic current calculated by the electromagnetic change amount processing unit.

According to an aspect of the invention, an electromagnetic distribution processing method is executed by a computer for calculating an electromagnetic distribution over areas that are spatially discretized. The electromagnetic distribution processing method includes calculating a physical amount of an electromagnetic current in each of the areas based on an electromagnetic field intensity; calculating, for each of the areas, a temporal change amount of the physical amount of the electromagnetic current calculated at the calculating of the physical amount; and calculating, for each of the areas, a cumulative value that is obtained by accumulating the temporal change amounts of the physical amount of the electromagnetic current calculated at the calculating of the temporal change amount.

According to an aspect of the invention, a computer-readable recording medium records an electromagnetic distribution processing program that causes a computer to execute a process of calculating an electromagnetic distribution over areas that are spatially discretized. The process includes calculating a physical amount of an electromagnetic current in each of the areas based on an electromagnetic field intensity; calculating, for each of the areas, a temporal change amount of the physical amount of the electromagnetic current calculated at the calculating of the physical amount; and calculating, for each of the areas, a cumulative value that is obtained by accumulating the temporal change amounts of the physical amount of the electromagnetic current calculated at the calculating of the temporal change amount.

The object and advantages of the invention will be realized and attained by means of the elements and combinations particularly pointed out in the appended claims. It is to be understood that both the foregoing general description and the following detailed description are exemplary and explanatory and are not restrictive of the invention, as claimed.

### BRIEF DESCRIPTION OF THE DRAWINGS

FIG. 1 is a perspective view of a computer system to which an electromagnetic distribution processing device according to an embodiment of the present invention is applied;

FIG. 2 is a block diagram of relevant configurations in a main unit of the computer system;

FIGS. 3A and 3B illustrate an electronic device in which the electromagnetic distribution is calculated by the electromagnetic distribution processing device according to the present embodiment, where FIG. 3A is a perspective transparent view of the electronic device and FIG. 3B illustrates a printed circuit board included in the electronic device;

FIG. 4 illustrates an example of CAD data used by the electromagnetic distribution processing device according to the present embodiment;

FIG. 5 is a functional block diagram of the electromagnetic distribution processing device according to the present embodiment;

FIG. 6 illustrates an example of an analysis model used by the electromagnetic distribution processing device according to the present embodiment;

FIGS. 7A and 7B indicate examples of electric current density change amount cumulative data calculated by the electromagnetic distribution processing device according to the present embodiment, where FIG. 7A indicates the cumulative value SumΔI x, y, z of change amounts of the electric current density and FIG. 7B indicates the cumulative value SumΔJ x, y, z of change amounts of the magnetic current density;

FIG. 8 is a flowchart of a method of calculating the electric current density performed by the electromagnetic distribution processing device according the present embodiment;

FIG. 9 indicates the electric current density and cumulative values of change amounts of the electric current density calculated by the electromagnetic distribution processing device according to the present embodiment;

FIG. 10 indicates the electric current density and cumulative values of change amounts of the electric current density calculated by the electromagnetic distribution processing device according to the present embodiment;

FIGS. 11A and 11B illustrate examples where final cumulative values of change amounts of the electric current density are displayed on a display screen of a display unit by the electromagnetic distribution processing device according to the present embodiment; and

FIGS. 12A through 12C illustrate comparative examples of displayed electric current density distributions at a certain time point, where FIG. 12A illustrates the electric current density distribution by gradations, FIG. 12B illustrates the electric current density distribution by cones of different densities, and FIG. 12C illustrates the electric current density distribution by contour lines.

### DESCRIPTION OF EMBODIMENTS

As described previously, at the stage of designing an electronic device, it is important to accurately identify the propagation paths of the signals when configuring the wires used for transmitting high-speed signals.

In order to accurately identify the propagation paths of the signals, the electric current distribution or the magnetic current distribution in the transmission paths needs to be identified. However, a large number of transmission paths are included in a multi-layer printed circuit board.

For example, an FDTD method (finite-difference time-domain method) is performed to three-dimensionally (spatially) discretize (segment) a part of the multi-layer printed circuit board and obtain the temporal changes in the electric current distribution based on the distribution of the magnetic field. It is assumed that this method uses a lattice-like analysis model that is divided into 100 cells in the X axial direction, the Y axial direction, and the Z axial direction. Calculation is performed on an analysis model including 10⁶ cells that are discretized as 100 (X direction)×100 (Y direction)×100 (Z direction). The calculation is performed at every 10 fs for the duration of 10 ns. Accordingly, the obtained number of data items amounts to 10⁶×10e⁻⁹/10e⁻¹⁵=1e¹². For each cell, the electric field and magnetic field in the X axial direction, the Y axial direction, and the Z axial direction need to be stored as the calculation result. Assuming that each data item is 4 byte data of a single precision type (floating point), the storage area for each cell needs to store 4 bytes×3 (X, Y, and Z axial directions)×2 (electric field and magnetic field)=24 bytes. Accordingly, the total data volume obtained by calculating the temporal changes in the electric current distribution for the above analysis model is 24 TB. Thus, a large capacity memory is needed for storing the data. Similarly, also in the case of obtaining the temporal changes in the magnetic current distribution, a large amount of data needs to be stored.

As described above, the volume of the data expressing the electric current distribution in time series is large. Therefore, it is unrealistic to obtain the temporal changes in the electric current distribution for all of the transmission paths. For this reason, in the conventional technology, only some of the transmission paths of signals are identified. Specifically, the conventional technology identifies only the transmission paths in which the signal waveform is likely to become deformed.

Furthermore, it is unrealistic to analyze all of the transmission paths, in both cases of identifying the transmission paths of the signals by analyzing the electric current distribution and by analyzing the magnetic current distribution. Thus, in the latter case also, the conventional technology identifies only the transmission paths in which the signal waveform is likely to become deformed.

As described above, the volume of the data expressing the electric current distribution in time series is large. Thus, it is difficult to confirm the electric current distribution or the magnetic current distribution in all of the areas at once. Accordingly, the printed circuit board is conventionally divided into plural areas. The process of calculating the temporal changes in the electric current distribution or the magnetic current distribution in each area is repeatedly performed only for the transmission paths in which the signal waveform is likely to become deformed. In this manner, the temporal changes in the electric current distribution or the magnetic current distribution are calculated for the entire printed circuit board. However, it takes extensive time to calculate the temporal changes in the electric current distribution or the magnetic current distribution in the above described manner. This is not helpful in reducing the TAT (Turn Around Time) and thus degrades efficiency.

One approach is to provide a large memory capacity for accommodating the large data volume. However, a display device has limited processing speed, and therefore the electric current distribution or the magnetic current distribution expressed by a large amount of terabyte-order data may not be displayed on the display device within a short period of time. Hence, even with this approach, it is difficult to display all of the data under practical situations.

Furthermore, the transmission paths in which the signal waveform is likely to become deformed are chosen based on the intuition of a skilled circuit designer. Therefore, the calculation results may differ among circuit designers having various levels of skills. When the initially chosen transmission paths turn out to be the wrong ones, the transmission paths need to be chosen once again, which degrades the efficiency of analysis.

Furthermore, data expressing the electric current distribution or the magnetic current distribution in time series, is created for each of the small time segments in the time axis. This also causes an increase in the data volume.

Preferred embodiments of the present invention will be explained with reference to accompanying drawings.

In embodiments of the present invention, the term “electromagnetic current” includes the meanings of both “electric current” and “magnetic current”.

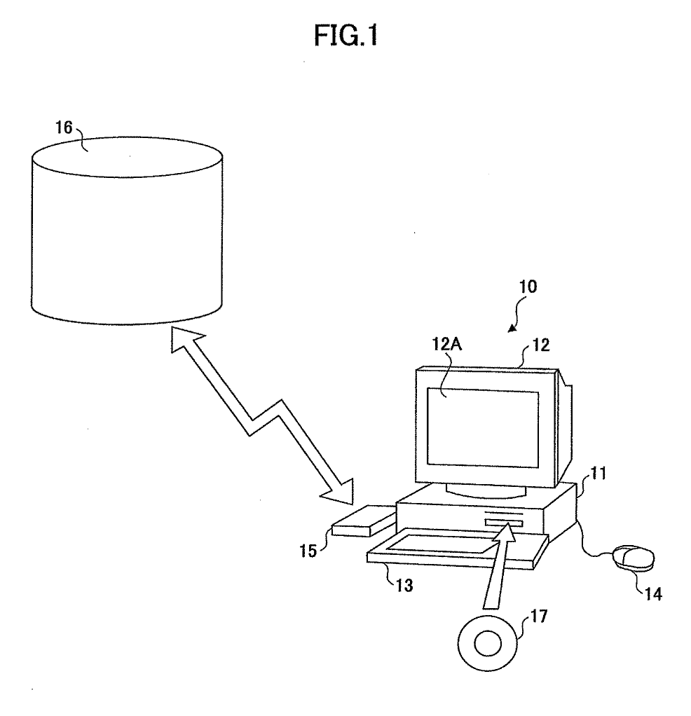

FIG. 1 is a perspective view of a computer system to which an electromagnetic distribution processing device according to an embodiment of the present invention is applied. As illustrated in FIG. 1, a computer system 10 includes a main unit 11, a display unit 12, a keyboard 13, a mouse 14, and a modem 15.

The main unit 11 has built-in elements such as a CPU (Central Processing Unit), a HDD (Hard Disk Drive), and a disk drive. The display unit 12 is for displaying analysis results on a display screen 12A in response to instructions from the main unit 11. An example of the display unit 12 is a liquid crystal monitor. The keyboard 13 is an input unit used for inputting various information items to the computer system 10. The mouse 14 is an input unit used for specifying particular positions on the display screen 12A. The modem 15 is for accessing external databases to download programs stored in other computer systems.

An electromagnetic distribution processing program (electromagnetic distribution processing program software or tool) is installed in the computer system 10 to provide the computer system 10 with a function for calculating the electromagnetic distribution. The electromagnetic distribution processing program may be stored in a transportable recording medium such as a disk 17, or may be downloaded from a recording medium 16 of another computer system with the use of a communications device such as the modem 15. The electromagnetic distribution processing program is installed and compiled in the computer system 10.

The electromagnetic distribution processing program causes the computer system 10 (i.e., a CPU 21 described below) to operate as an electromagnetic distribution processing device (or an electromagnetic distribution processing system) having a function of calculating the electromagnetic distribution. The electromagnetic distribution processing program may be stored in a computer-readable recording medium such as the disk 17. A computer-readable recording medium is not limited to a transportable recording medium such as the disk 17, an IC card memory, a magnetic current disk such as a floppy disk (registered trademark), a magnet-optical disk, and a CD-ROM; the computer-readable recording medium may be any recoding medium that may be accessed by a computer system that is connected via a communications device such as the modem 15 or a LAN.

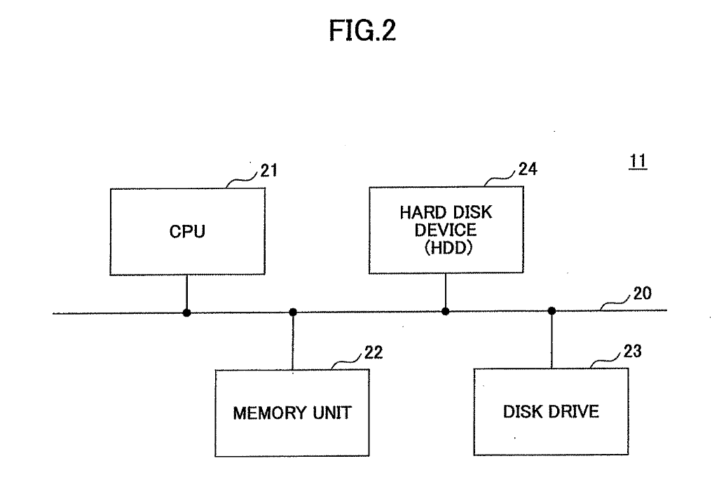

FIG. 2 is a block diagram of relevant configurations in the main unit 11 of the computer system 10. The main unit 11 includes the processor (CPU) 21, a memory unit 22 including a RAM or a ROM, a disk drive 23 for the disk 17, and a hard disk drive (HDD) 24, which are connected via a bus 20. In the present embodiment, the display unit 12, the keyboard 13, and the mouse 14 are connected to the CPU 21 via the bus 20; however, these elements may be directly connected to the CPU 21. Furthermore, the display unit 12 may be connected to the CPU 21 via a known graphic interface (not illustrated) for processing input/output image data.

In the computer system 10, the keyboard 13 and the mouse 14 form an input unit of the electromagnetic distribution processing device. The display unit 12 is a display unit for displaying the calculation results of the electromagnetic distribution on the display screen 12A. The CPU 21 functions as at least an electromagnetic processing unit for obtaining the physical amount of the electromagnetic current in each area based on the electromagnetic field intensity; an electromagnetic change amount processing unit for obtaining, for each area, the temporal change amount of the physical amount of the electromagnetic current calculated by the electromagnetic processing unit; and a cumulative change amount processing unit for obtaining, for each area, the cumulative value obtained by cumulating the temporal change amounts of the physical amount of the electromagnetic current calculated by the electromagnetic change amount processing unit.

The configuration of the computer system 10 is not limited to that illustrated in FIGS. 1 and 2; various known elements may be added or may be used instead of the above-described elements.

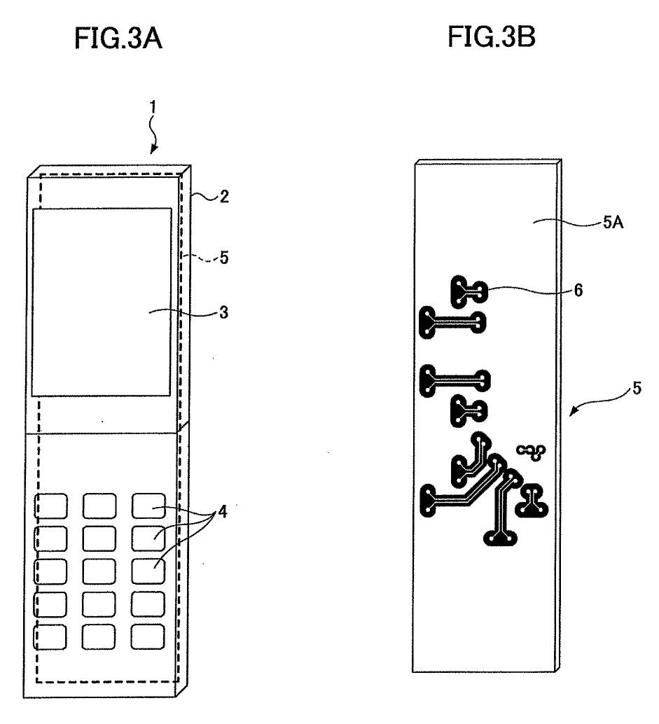

FIGS. 3A and 3B illustrate an electronic device in which the electromagnetic distribution is calculated by the electromagnetic distribution processing device according to the present embodiment. FIG. 3A is a perspective transparent view of the electronic device and FIG. 3B illustrates a printed circuit board included in the electronic device. In the present embodiment, a mobile phone 1 is given as an example of the electronic device.

As illustrated in FIG. 3A, on the outside of a casing 2 of the mobile phone 1, a display unit 3 and an operations unit 4 are provided. Inside the casing 2, there is a printed circuit board 5 indicated by dashed lines.

The casing 2 is made of resin or metal, and has openings in which the display unit 3 and the operations unit 4 are set. The display unit 3 may be a liquid crystal panel for displaying characters, numbers, and images. The operations unit 4 includes a numeric keypad as well as various selection keys for selecting functions of the mobile phone 1. The mobile phone 1 may include accessory devices such as a proximity communications device (infrared communications device, communications device for electronic money) or a camera.

The printed circuit board 5 illustrated in FIG. 3B is formed by FR4 (glass reinforced epoxy laminated sheets). A conductive pattern 6 is formed on a surface 5A of the printed circuit board 5 by applying copper foil by a patterning method. The conductive pattern 6 forms the transmission paths of various signals used for operating the electronic device. The conductive pattern 6 may be formed by an etching process with the use of a resist material.

An IC (Integrated Circuit) and a memory are electrically connected to the conductive pattern 6. The IC and memory are used by the mobile phone 1 for performing communications with phone calls, e-mails, and the Internet.

The FR4 forming the printed circuit board 5 is typically formed by laminating plural insulating layers, and applying copper foil by a pattern method in between the insulating layers, on the topmost surface of the laminated structure, and on the bottommost surface of the laminated structure.

Accordingly, wirings and circuits used by the mobile phone 1 for performing communications with phone calls, e-mails, and the Internet, may be formed between layers or on the bottommost surface of the FR4.

The printed circuit board 5 may be any dielectric current board other than FR4, as long as the conductive pattern 6 is formed and a circuit is installed.

Furthermore, the conductive pattern 6 may be made of any kind of metal other than copper (Cu) (for example, aluminum (Al)), as long as the metal has low power attenuation and high conductivity.

The CAD (Computer Aided Design) data of the conductive pattern 6 formed on the printed circuit board 5 is stored in the HDD 24 illustrated in FIG. 2.

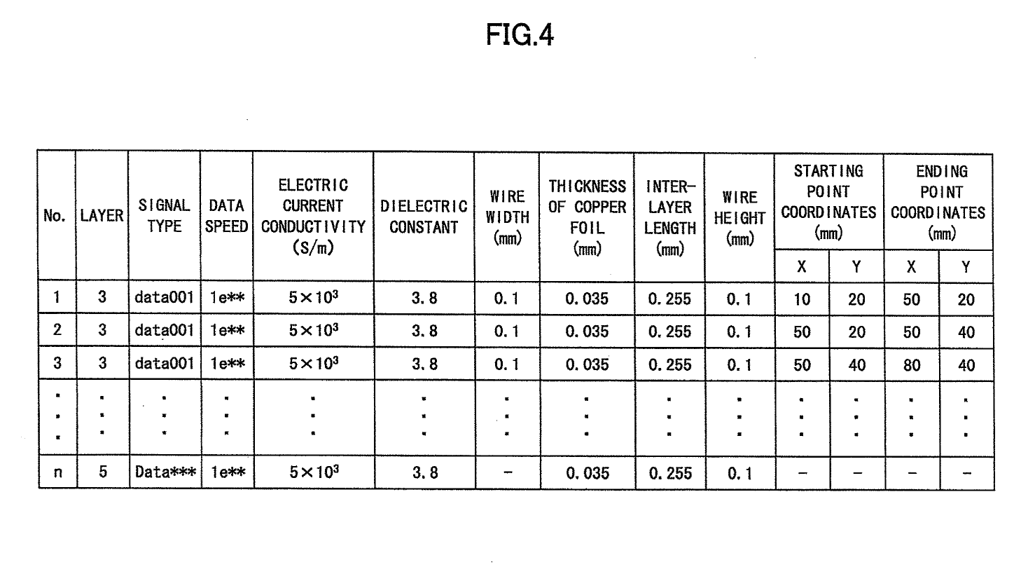

FIG. 4 illustrates an example of CAD data used by the electromagnetic distribution processing device according to the present embodiment. The CAD data includes the sizes of the layers included in the printed circuit board 5, the positions and sizes of via holes formed in the printed circuit board 5, the layer numbers of the conductive patterns 6 formed in the printed circuit board 5, the types of signals, data speed, dielectric constants, electric current conductivity, widths of wires, thickness of copper foil, inter-layer lengths, wire heights, starting point positions, and ending point positions. The starting point positions and the ending point positions are expressed as lengths with respect to a predetermined reference position on the printed circuit board 5.

Next, a description is given of the method of calculating the electromagnetic distribution performed by the electromagnetic distribution processing device according to the present embodiment. In the following description, the HDD 24 illustrated in FIG. 2 stores the electromagnetic distribution processing program for causing the computer system 10 to function as an electromagnetic distribution processing device having a function of calculating the electromagnetic distribution.

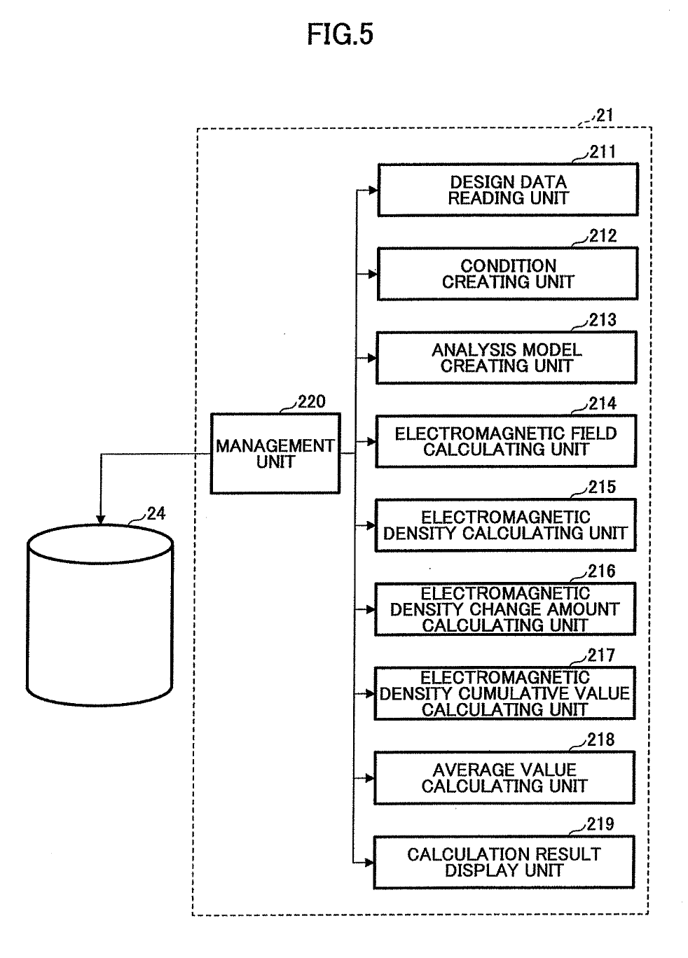

FIG. 5 is a functional block diagram of the electromagnetic distribution processing device according to the present embodiment. The functions are implemented when the CPU 21 executes the electromagnetic distribution processing program stored in the HDD 24.

The functions implemented by the CPU 21 include a design data reading unit 211, a condition creating unit 212, an analysis model creating unit 213, an electromagnetic field calculating unit 214, an electromagnetic density calculating unit 215, an electromagnetic density change amount calculating unit 216, an electromagnetic density cumulative value calculating unit 217, an average value calculating unit 218, a calculation result display unit 219, and a management unit 220.

The design data reading unit 211 reads the CAD data stored in the HDD 24.

The condition creating unit 212 creates analysis conditions for creating an analysis model described below. The analysis conditions are created based on conditions input via the keyboard 13 or the mouse 14. Examples of the input conditions are the area to be analyzed (analysis area), the number of segments into which the analysis area is divided in the X, Y, and Z axial directions (segment number), the time taken for the analysis (analysis time), and the time unit used for calculating the amount of change (change amount) in the electromagnetic current during the analysis time.

The analysis model creating unit 213 discretizes the three dimensional space including the printed circuit board 5 and the conductive pattern 6 based on data expressing the analysis area and the segment number, among the analysis conditions created by the condition creating unit 212, and creates the analysis model.

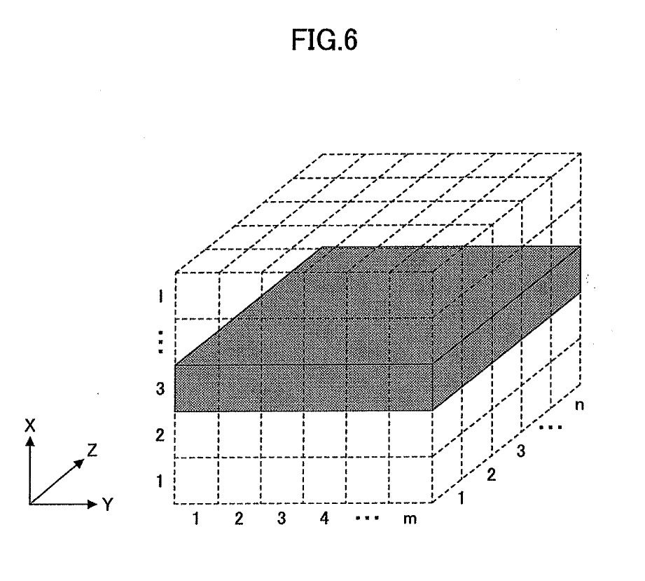

The analysis model is a spatial model that divides a part (three-dimensional area) of the printed circuit board 5 and the conductive pattern 6 included in the analysis area. Specifically, the part is divided by the segment number into cells in the X, Y, and Z axial directions, as illustrated in FIG. 6.

FIG. 6 illustrates an example of an analysis model used by the electromagnetic distribution processing device according to the present embodiment. As illustrated in FIG. 6, the analysis model is divided into “1” cells in the X axial direction (“1” being an integer greater than or equal to 2), “m” cells in the Y axial direction (“m” being an integer greater than or equal to 2), and “n” cells in the Z axial direction (“n” being an integer greater than or equal to 2). Accordingly, the analysis model includes cells that are three-dimensionally discretized. The coordinates of each of the cells are (X, Y, Z).

The electromagnetic field calculating unit 214 illustrated in FIG. 5 calculates the electromagnetic field data for each cell and each time unit by an FDTD method, for example. Specifically, the electromagnetic field data is calculated at every time unit Δt from an initial time point t0 for the duration of t1 to t_{end}, to obtain electromagnetic field data that expresses the intensity and direction of the electromagnetic field during the analysis time t1 to t_{end}.

The initial value of the electromagnetic field data (initial value expressing the intensity and direction of the magnetic current field and the electric field) is obtained by the electromagnetic field calculating unit 214 based on the types of signals included in the CAD data, the data speed, and the dielectric constant. The initial value of the electromagnetic field data may be set at zero for the intensities of both the magnetic field and the electric field.

In the electromagnetic field data, the magnetic field data at a time point t is expressed by “H x, y, z (t)” and the electric field data at a time point t is expressed by “E x, y, z (t)”. The magnetic field data “H x, y, z (t)” includes values corresponding to the intensity (scalar amount) and components in the X, Y, and Z axial directions. Similarly, the electric field data “E x, y, z (t)” includes values corresponding to the intensity (scalar amount) and components in the X, Y, and Z axial directions.

The magnetic field data “H x, y, z (t)” of each cell is obtained by calculating six normal vectors (two in each of the X, Y, and Z axial directions) expressing the intensities and directions of the magnetic fields passing through the six surfaces of the cell, and calculating the intensity (scalar amount) and direction of each vector that is derived as the average value of magnetic fields of two normal vectors in the respective axial directions.

Furthermore, the electric field data “E x, y, z (t)” of each cell is obtained by calculating the electric field at each of the 12 sides surrounding the cell (four sides in each of the X, Y, and Z axial directions), and calculating the average value of the electric fields of the four sides in the respective the axial directions, to obtain electric field values.

The electromagnetic density calculating unit 215 performs contour integration on the magnetic field data “H x, y, z (t)” calculated by the electromagnetic field calculating unit 214 to obtain an electric current density “I x, y, z (t)” at a time point t. Furthermore, the electromagnetic density calculating unit 215 performs contour integration on the electric field data “E x, y, z (t)” to obtain a magnetic current density “J x, y, z (t)” at a time point t. The electric current density “I x, y, z (t)” and the magnetic current density “J x, y, z (t)” are obtained as physical amounts of the electromagnetic current.

The electric current density “I x, y, z (t)” includes values of the electric current density as well as values of components of the X, Y, and Z axial directions. The magnetic current density “J x, y, z (t)” includes values of the magnetic current density as well as values of components of the X, Y, and Z axial directions.

The electromagnetic density change amount calculating unit 216 uses the following formulae (1) and (2) to calculate the absolute values of the change amounts of the electric current density “I x, y, z (t)” and the magnetic current density “J x, y, z (t)”, for each time unit.

ΔIx,y,z(t)=|Ix,y,z(t)−Ix,y,z(t−Δt)| (1)

ΔJx,y,z(t)=|Jx,y,z(t)−Jx,y,z(t−Δt)| (2)

By using the above formula (1), the absolute value of the change amount of the electric current density “ΔI x, y, z (t)” is obtained. By using the above formula (2), the absolute value of the change amount of the magnetic current density “ΔJ x, y, z (t)” is obtained.

As described above, the electromagnetic density change amount calculating unit 216 calculates the absolute values of the change amounts of the electric current density “I x, y, z (t)” and the magnetic current density “J x, y, z (t)”, for each time unit during the analysis time (t1 to t_{end}).

The change amount of the electric current density “ΔI x, y, z (t)” includes values of components in the X, Y, and Z axial directions. The change amount of the magnetic current density “ΔJ x, y, z (t)” also includes values of components in the X, Y, and Z axial directions.

The electromagnetic density cumulative value calculating unit 217 uses the following formula (3) to calculate, for each cell, the cumulative value of the change amounts of the electric current density at a time point t. This calculation is performed based on the change amounts of the electric current density “ΔI x, y, z (t)” until a time point t that is calculated by the electromagnetic density change amount calculating unit 216. This process is repeated until a time point t_{end}.

SumΔIx,y,z=Σ_{t=t1, tend}ΔIx,y,z(t) (3)

The cumulative value of the change amounts of the electric current density for each cell represents the electric current density distribution.

In a similar manner, the electromagnetic density cumulative value calculating unit 217 uses the following formula (4) to calculate, for each cell, the cumulative value of the change amounts of the magnetic current density at a time point t. This calculation is performed based on the change amounts of the magnetic current density “ΔJ x, y, z (t)” until a time point t that is calculated by the electromagnetic density change amount calculating unit 216. This process is repeated until a time point t_{end}.

SumΔJx,y,z=Σ_{t=t, tend}ΔJx,y,z(t) (4)

The cumulative value of the change amounts of the magnetic current density for each cell represents the magnetic current density distribution.

In the present embodiment, the electromagnetic density cumulative value calculating unit 217 calculates the cumulative value of the change amounts of the electric current density, by accumulating all of the change amounts (absolute values) of the electric current density during the analysis time (t1 to t_{end}). However, when the value is likely to deviate significantly due to noise, it may be preferable not to accumulate such a change amount having significant deviation, to obtain a final cumulative value having high reliability. For example, a lower limit threshold and an upper limit threshold of the change amount (absolute value) are stored in the memory unit 22. Before the electromagnetic density cumulative value calculating unit 217 performs accumulation, the change amounts are compared with the lower limit threshold and the upper limit threshold. Only the change amounts that are between the lower limit threshold and the upper limit threshold are accumulated to calculate the SumΔI x, y, z of the change amounts of the electric current density. The same applies to the SumΔJ x, y, z of the change amounts of the magnetic current density.

In some electronic devices, there may be a case where the rise time taken to switch to a steady state is already known, or there may be a case of accumulating only the change amounts of the electric current density during a particular time period in the analysis time (t1 to t_{end}). In these cases, the starting time and ending time of accumulating the change amounts of the electric current density may be set at particular time points within the analysis time (t1 to t t_{end}). Accordingly, the electromagnetic density cumulative value calculating unit 217 calculates the accumulative value by accumulating only the change amounts of electric current density between the set starting time and ending time.

Furthermore, in some electronic devices, there may be a case of accumulating only the change amounts of electric current density included within a particular area in the analysis area (X, Y, Z)=(1, 1, 1) through (l, m, n). In this case, the starting coordinates and ending coordinates for accumulating the change amounts of electric current density may be set at particular positions in the analysis area. Accordingly, the electromagnetic density cumulative value calculating unit 217 calculates the accumulative value by accumulating only the change amounts of electric current density between the set starting coordinates and ending coordinates.

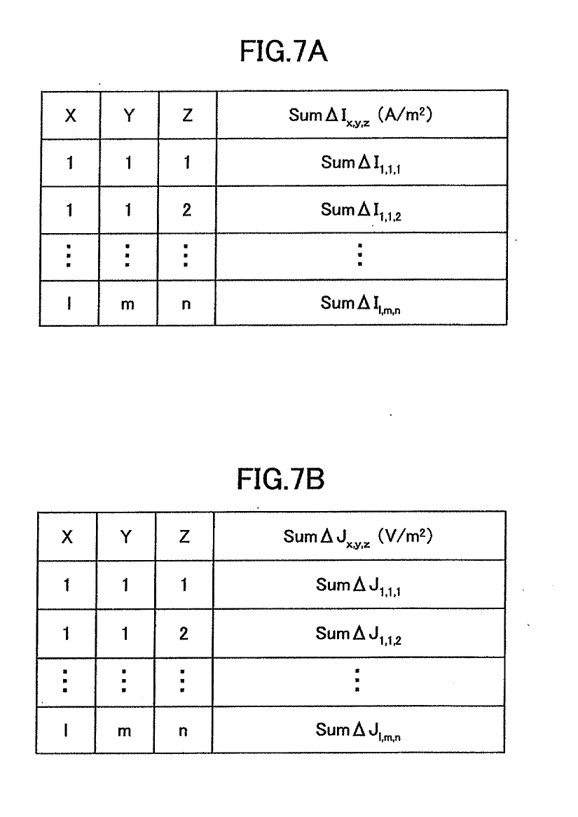

FIGS. 7A and 7B indicate examples of electric current density change amount cumulative data calculated by the electromagnetic distribution processing device according to the present embodiment. FIG. 7A indicates the cumulative values SumΔI x, y, z of the change amounts of the electric current density, and FIG. 7B indicates the cumulative values SumΔJ x, y, z of the change amounts of the magnetic current density.

As described above, the electromagnetic density cumulative value calculating unit 217 calculates the cumulative value of the change amounts of the electric current density SumΔI x, y, z and the cumulative value of the change amounts of the magnetic current density SumΔJ x, y, z. The cumulative values for each of the cells are stored in the HDD 24 as indicated in FIGS. 7A and 7B.

The cumulative value of the change amounts of the electric current density SumΔI x, y, z and the cumulative value of the change amounts of the magnetic current density SumΔJ x, y, z are values obtained by accumulating the absolute values of change amounts of the electric current density and the magnetic current density up to a time point t, in each cell. Accordingly, the cumulative value expresses the extent of change in the electric current and the magnetic current in each cell.

Furthermore, the cumulative value of the change amounts of the electric current density SumΔI x, y, z and the cumulative value of the change amounts of the magnetic current density SumΔJ x, y, z are obtained by accumulating the change amounts of the electric current density and the magnetic current density in the temporal direction. Therefore, each cell only needs to have one data item. Thus, the data volume may be reduced.

The average value calculating unit 218 illustrated in FIG. 5 calculates the average value of the cumulative values of the change amounts of the electric current density SumΔI x, y, z obtained for each of the cells by the electromagnetic density cumulative value calculating unit 217. The average value calculating unit 218 also calculates the average value of the cumulative values of the change amounts of the magnetic current density SumΔJ x, y, z obtained for each of the cells by the electromagnetic density cumulative value calculating unit 217.

The average values may be calculated based on the cumulative values of the change amounts of the electric current density SumΔI x, y, z and the cumulative values of the change amounts of the magnetic current density SumΔJ x, y, z of all of the cells. However, in another example, the average values may be calculated based on cumulative values within a standard deviation as described below, when values are likely to deviate due to noise.

The average value calculating unit 218 uses the following formula (5) to calculate the average value of cumulative values within a predetermined standard deviation ±σ_{I}, among cumulative values of the change amounts of the electric current density SumΔI x, y, z.

AveΔI=1/aΣx=1, 1 Σy=1, mΣz=1,nSumΔIx,y,z (5)

In formula (5), “a” expresses the number of cumulative values within the predetermined standard deviation ±σ_{I}, among cumulative values of the change amounts of the electric current density SumΔI x, y, z.

Similarly, the average value calculating unit 218 uses the following formula (6) to calculate the average value of cumulative values within a predetermined standard deviation ±σ_{J}, among cumulative values of the change amounts of the magnetic current density SumΔJ x, y, z.

AveΔJ=1/bΣx=1, 1Σy=1, mΣz=1,nSumΣJx,y,z (6)

In formula (6), “b” expresses the number of cumulative values within the predetermined standard deviation ±σ_{J}, among cumulative values of the change amounts of the magnetic current density SumΔJ x, y, z.

In this embodiment, the average value calculating unit 218 calculates the average value of the cumulative values within a standard deviation (±σ_{I}, ±σ_{J}). However, in another example, the average value calculating unit 218 may calculate the average value of the cumulative values having a predetermined difference with respect to the average value of all of the cumulative values (plus/minus a threshold).

The calculation result display unit 219 illustrated in FIG. 5 displays, on the display screen 12A of the display unit 12 illustrated in FIG. 1, the cumulative values of change amounts of the electric current density or the magnetic current density calculated by the electromagnetic density cumulative value calculating unit 217. The displayed contents are described below.

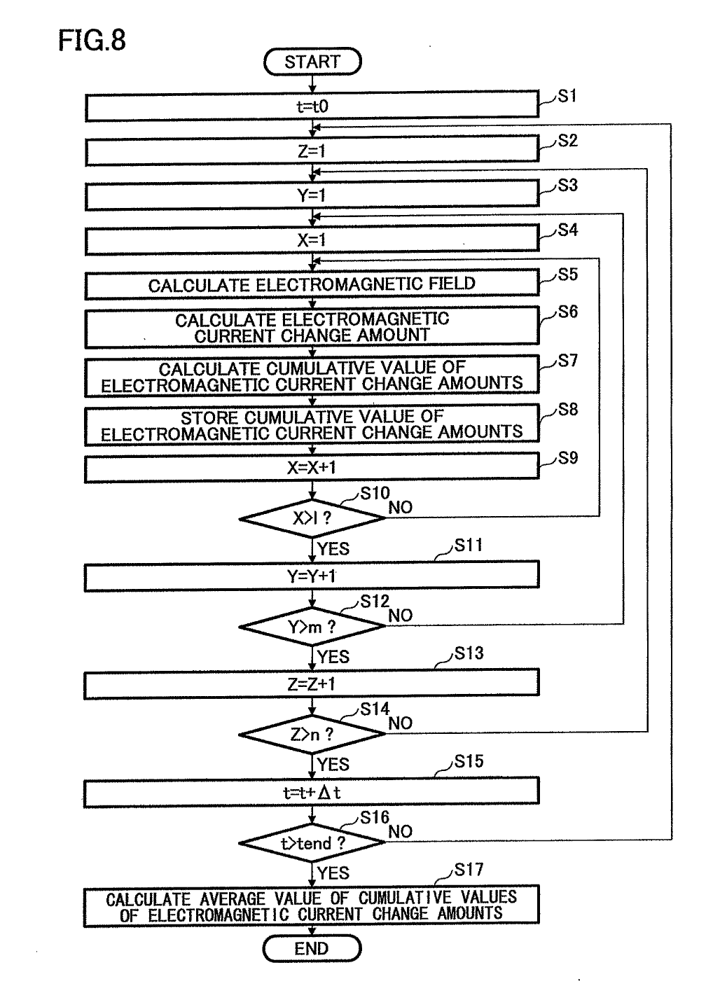

The management unit 220 illustrated in FIG. 5 is a data management unit for managing the operation of storing data into the HDD 24. The contents of the process performed by the management unit 220 are described with reference to the flowchart illustrated in FIG. 8.

FIG. 8 is a flowchart of a method of calculating the electric current density performed by the electromagnetic distribution processing device according the present embodiment. The calculation of FIG. 8 is performed as the CPU 21 executes an electromagnetic distribution processing program according to the present embodiment for causing the electromagnetic distribution processing device to have a function of calculating the electromagnetic distribution. It is assumed that the calculation time tends from t1 (starting time) to t_{end} (ending time).

Furthermore, in this process, the electromagnetic distribution processing device calculates the cumulative values of the change amounts of the electric current density and the magnetic current density for each of the cells included in the analysis area (X=1˜1, Y=1˜m, Z=1˜n), in an order starting from cells of smaller coordinate values to cells of larger coordinate values. The calculation process is performed in a sequential order in the X, Y, and Z axial directions starting from a cell having coordinates of (X,Y,Z)=(1,1,1) until a cell having coordinates of (X,Y,Z)=(l,m,n).

When the calculation process starts, the CPU 21 sets the time point t of performing the analysis to a starting time point t0 (step S1).

Next, the CPU 21 sets the Z coordinate in the analysis area to Z=1 (step S2). The calculation in the Z direction is sequentially performed by incrementing the coordinate value from Z=1 to Z=n.

Next, the CPU 21 sets the Y coordinate in the analysis area to Y=1 (step S3). The calculation in the Y direction is sequentially performed by incrementing the coordinate value from Y=1 to Y=m.

Next, the CPU 21 sets the X coordinate in the analysis area to X=1 (step S4). The calculation in the X direction is sequentially performed by incrementing the coordinate value from X=1 to X=1.

Next, the CPU 21 calculates the electromagnetic field (step S5). The calculation process at step S5 is performed to obtain a magnetic field Hx, y, z and an electric field Ex, y, z that has changed during a time unit, based on a value of the electromagnetic field before the time unit has elapsed, the data speed and dielectric constant. The calculation process of step S5 is performed by the electromagnetic field calculating unit 214 in the functional blocks in the CPU 21 illustrated in FIG. 5. The value of the electromagnetic field before a time unit has elapsed is temporarily stored in the RAM of the memory unit 22.

The CPU 21 performs contour integration on the magnetic field Hx, y, z obtained at step S5 to calculate the electric current density Ix, y, z in the cell. Furthermore, the CPU 21 performs contour integration on the electric field Ex, y, z obtained at step S5 to calculate the magnetic current density Jx, y, z in the cell. The CPU 21 uses the above formulae (1) and (2) to calculate, for each time unit, the change amounts ΔIx, y, z(t) and ΔJx, y, z in the electric current density Ix, y, z and the magnetic current density Jx, y, z, respectively (step S6). The calculation process of step S6 is performed by the electromagnetic density calculating unit 215 and the electromagnetic density change amount calculating unit 216 in the functional blocks in the CPU 21 illustrated in FIG. 5.

The CPU 21 uses the above formulae (3) and (4) to accumulate the change amounts ΔIx, y, z(t) of the electric current density and the change amounts ΔJx, y, z of the magnetic current density calculated at step S6, and to calculate the cumulative value SumΔIx, y, z of the change amounts of the electric current density until a time point t and the cumulative value SumΔJx, y, z of the change amounts of the magnetic current density until a time point t (step S7). The calculation process at step S7 is performed by the electromagnetic density cumulative value calculating unit 217 in the functional blocks in the CPU 21 illustrated in FIG. 5.

Next the CPU 21 stores, in the HDD 24, the cumulative value SumΔIx, y, z of the change amounts of the electric current density and the cumulative value SumΔJx, y, z of the change amounts of the magnetic current density calculated in step S7, corresponding to the cell. The process of storing the cumulative values in the HDD 24 at step S8 is performed by the management unit 220 in the functional blocks in the CPU 21 illustrated in FIG. 5

Among the values calculated by the CPU 21 in steps S5 through S7, the only data stored in the HDD 24 by the management unit 220 is the cumulative values SumΔIx, y, z of the change amounts of the electric current density and the cumulative values SumΔJx, y, z of the change amounts of the magnetic current density, which are calculated at step S7. That is to say, the management unit 220 stores the cumulative values in the HDD 24 when the electromagnetic density calculating unit 215 has calculated the electromagnetic density for a particular cell, the electromagnetic density change amount calculating unit 216 has calculated the temporal change amounts of the electromagnetic density for the particular cell, and the electromagnetic density cumulative value calculating unit 217 has accumulated the calculated temporal change amounts of the electromagnetic density for the particular cell.

Thus, during the calculation, the CPU 21 temporarily stores, in the RAM of the memory unit 22, the magnetic field Hx, y, z, the electric field Ex, y, z, the electric current density Ix, y, z, and the magnetic current density Jx, y, z calculated at steps S5 and S6, according to need. Accordingly, the amount of data stored in the HDD 24 is reduced.

Next, the CPU 21 increments the X axis coordinate value (X=X+1) (step S9).

Then, the CPU 21 determines whether the X axis coordinate value satisfies X>1 (step S10). This is to determine whether the X axis coordinate value has reached the maximum value 1.

When the CPU 21 determines that X>1 is not satisfied at step S10, the flow returns to step S5, and repeats the process of steps S5 to S10.

When the CPU 21 determines that X>1 is satisfied at step S10, the flow proceeds to step S11, and increments the Y axis coordinate value (Y=Y+1) (step S11).

Then, the CPU 21 determines whether the Y axis coordinate value satisfies Y>m (step S12). This is to determine whether the Y axis coordinate value has reached the maximum value m.

When the CPU 21 determines that Y>m is not satisfied at step S12, the flow returns to step S4, and repeats the process of steps S4 to S12.

When the CPU 21 determines that Y>m is satisfied at step S12, the flow proceeds to step S13, and increments the Z axis coordinate value (Z=Z+1) (step S13).

Then, the CPU 21 determines whether the Z axis coordinate value satisfies Z>n (step S14). This is to determine whether the Z axis coordinate value has reached the maximum value n.

When the CPU 21 determines that Z>n is not satisfied at step S14, the flow returns to step S3, and repeats the process of steps S3 to S14.

When the CPU 21 determines that Z>n is satisfied at step S14, the flow proceeds to step S15, and adds a time unit Δt to the analysis time t (step S15). This is to calculate the magnetic field, the electric field, the electric current density, and the magnetic current density, for each of the cells every time a time unit has elapsed. The time unit Δt corresponds to the time duration between each of the time points in the analysis time, and the time unit Δt may be freely set.

The CPU 21 determines whether t>tend is satisfied between the analysis time t and the ending time tend (step S16). This is because the process of steps S2 through S16 is repeatedly executed until the ending time point tend.

When the CPU 21 determines that t>tend is not satisfied at step S16, the flow returns to step S2, and the process of steps S2 through S16 is repeated executed.

When the CPU 21 determines that t>tend is satisfied at step S16, the flow proceeds to step S17, and uses the above formulae (5) and (6) to calculate the average value AveΔI of cumulative values of change amounts of the electric current density and the average value AveΔJ of cumulative values of change amounts of the magnetic current density, respectively (step S17). Step S17 is executed by the average value calculating unit 218 in the functional blocks in the CPU 21 illustrated in FIG. 5.

In step S17, the average value AveΔI is calculated for cumulative values within a predetermined standard deviation of ±σ_{I}, among the cumulative values SumΔIx, y, z of change amounts of the electric current density. Furthermore, the average value AveΔJ is calculated for cumulative values within a predetermined standard deviation of ±σ_{J}, among the cumulative values SumΔJx, y, z of change amounts of the magnetic current density.

Accordingly, the CPU 21 ends the calculation of change amounts of the electric current density, the change amounts of the magnetic current density, the cumulative values of absolute values of change amounts of the electric current density and the magnetic current density, and average values of the cumulative values of the electric current density and the magnetic current density, in the analysis model of the electromagnetic distribution processing device according to the present embodiment (END).

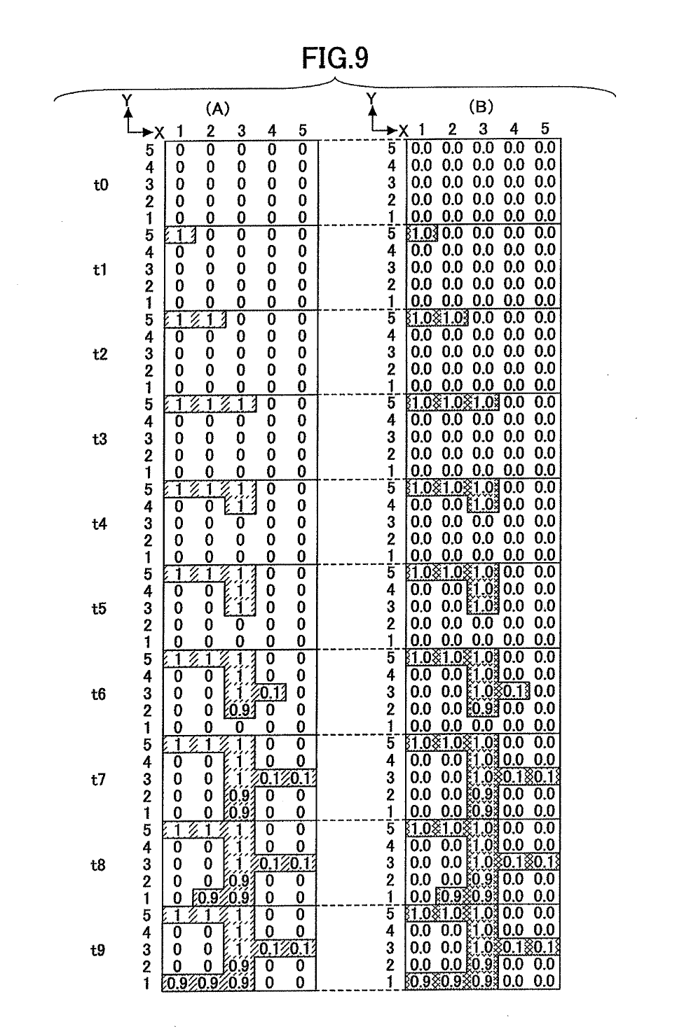

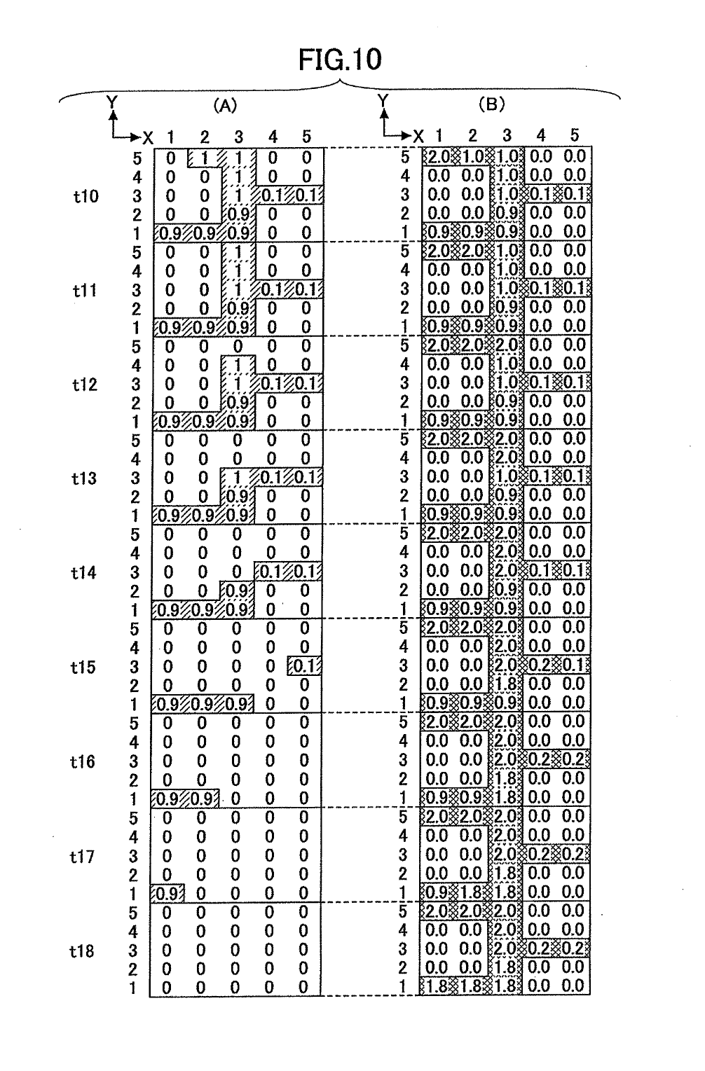

FIGS. 9 and 10 indicate the electric current density and cumulative values of change amounts of the electric current density, calculated by the electromagnetic distribution processing device according to the present embodiment. As a matter of convenience, only the electric current density and cumulative values of change amounts of the electric current density are described herein; however, the same description is applicable to the magnetic current density and cumulative values of change amounts of the magnetic current density.

In FIGS. 9 and 10, the data (A) on the left side indicates the electric current densities at each time point during time points t0 to t18. In FIGS. 9 and 10, the data (B) on the right side indicates cumulative values of change amounts of the electric current densities at each time point during time points t0 to t18.

As a matter of convenience, in FIGS. 9 and 10, each section surrounded by a frame includes 25 cells (5 cells in the X axis direction and 5 cells in the Y axis direction), which are arranged in one of the layers having the same Z axis coordinate value. In each of these sections, the electric current densities and the cumulative values of change amounts of the electric current density are indicated by simple figures.

Furthermore, as a matter of convenience, coordinate values of 1 through 5 along the X axis and Y axis are allocated for the electric current density distribution at each time point. That is to say, among the 25 cells at each time point, the bottom left cell has coordinates of (X,Y)=(1, 1) and the top right cell has coordinates of (X,Y)=(5, 5).

As indicated in FIG. 9 (A), at time point t0, the electric current density is zero in all of the cells. Thus, as indicated in FIG. 9 (B), at time point t0, the cumulative value of change amounts of the electric current density is zero in all of the cells.

As indicated in FIG. 9 (A), at time point t1, the electric current density is 1 in cell (X, Y)=(1, 5), which indicates that the electric current has started to flow. Thus, as indicated in FIG. 9 (B), at time point t1, the cumulative value of the change amount of the electric current density is 1.0 in cell (X, Y)=(1, 5).

As indicated in FIG. 9 (A), at time points t2 through t5, the electric current density sequentially becomes 1 in cells (X, Y)=(2, 5), (3, 5), (3, 4), (3, 3), which indicates that the electric current is flowing in. Thus, as indicated in FIG. 9 (B), the cumulative value of the change amount of the electric current density sequentially becomes 1.0 in cells (X, Y)=(2, 5), (3, 5), (3, 4), (3, 3)

As indicated in FIG. 9 (A), at time point t6, the current flow branches into a cell (X, Y)=(3, 2) and a cell (X, Y)=(4, 3), having electric current densities of 0.9 and 0.1, respectively. Thus, as indicated in FIG. 9 (B), the cumulative value of the change amount of the electric current density is 0.9 and 0.1 in cells (X, Y)=(3, 2) and (4, 3), respectively.

As indicated in FIG. 9 (A), at time points t7 through t9, the electric current with an electric current density of 0.9 sequentially flows into the cells (X, Y)=(3, 1), (2, 1), (1, 1). Meanwhile, the electric current with an electric current density of 0.1 flows into cell (X, Y)=(5, 3) at time point 7, and then flows outside of the 25 cells.

Thus, as indicated in FIG. 9 (B), at time points t7 through t9, the cumulative value of the change amount of the electric current density sequentially becomes 0.9 in cells (X, Y)=(3, 1), (2, 1), (1, 1). Furthermore, at time point t7 and onwards, the cumulative value of the change amount of the electric current density is 0.1 in cell (X, Y)=(5, 3).

As indicated in FIG. 10 (A), at time point t10, the electric current density becomes zero in cell (X, Y)=(1, 5). Thus, as indicated in FIG. 10 (B), which indicates cumulative values as change amounts of the electric current density, at time point t0, the cumulative value of change amount of the electric current density is 2.0 in cell (X, Y)=(1, 5).

As indicated in FIG. 10 (A), at time points t11 through t14, the electric current density sequentially becomes zero in cells (X, Y)=(2, 5), (3, 5), (3, 4), (3, 3). Thus, as indicated in FIG. 10 (B), at time points t11 through t14, the change amount (absolute value) in the electric current density sequentially becomes 2.0 in cells (X, Y)=(2, 5), (3, 5), (3, 4), (3, 3).

As indicated in FIG. 10 (A), at time point t15, the electric current density is zero in cells (X, Y)=(3, 2), (4, 3), and at time point t16, the electric current density is zero in cells (X, Y)=(3, 1), (5, 3). Thus, as indicated in FIG. 10 (B), at time point t15, the change amount (absolute value) in the electric current density is 1.8 and 0.2 in cells (X, Y)=(3, 2), (4, 3), respectively, and at time point t16, the change amount (absolute value) in the electric current density is 1.8 and 0.2 in cells (X, Y)=(3, 1), (5, 3), respectively.

As indicated in FIG. 10 (A), at time points t17 and t18, the electric current density sequentially becomes zero in cells (X, Y)=(2, 1), (1, 1). Thus, as indicated in FIG. 10 (B), at time points t17 and t18, the change amount (absolute value) in the electric current density is 1.8 in cells (X, Y)=(2, 1), (1, 1).

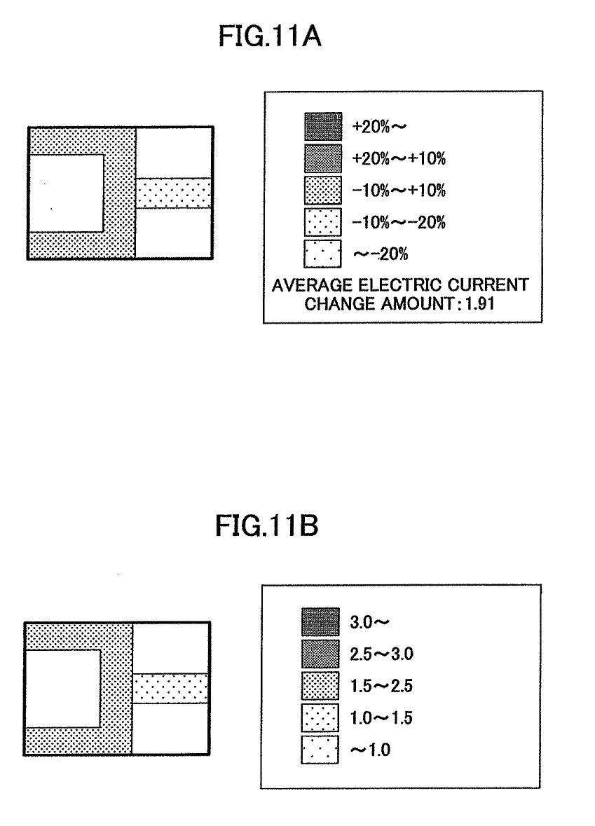

FIGS. 11A and 11B illustrate examples where the final cumulative values of the change amounts of the electric current density are displayed on the display screen 12A of the display unit 12 by the electromagnetic distribution processing device according to the present embodiment.

FIG. 11A illustrates an example in which the differences between the cumulative values and an average value (1.91) of the cumulative values are indicated by percentage ranges (˜−20%, −20%˜−10%, −10%˜+10%, +10%˜+20%, +20%˜), with dots of different densities in the respective ranges. FIG. 11B an example in which the cumulative values of the change amounts (absolute values) in the electric current density are segmented into value ranges (0˜1.0, 1.0˜1.5, 1.5˜2.0, 2.0˜2.5, 2.5˜3.0), with dots of different densities in the respective ranges.

In FIGS. 11A and 11B, dark dots correspond to cells representing high cumulative values of change amounts (absolute values) in the electric current density that have accumulated at the final time point t18 as indicated in FIG. 10 (B). Meanwhile, light dots correspond to cells representing low cumulative values, such as cells (X, Y)=(4, 3), (5, 3). The final cumulative values of change amounts (absolute values) in the electric current density are sums of the change amounts (absolute values) in the temporal direction, and therefore the data volume is low, and the transmission paths of the signals are correctly displayed. The same applies to cumulative values of change amounts (absolute values) in the magnetic current density.

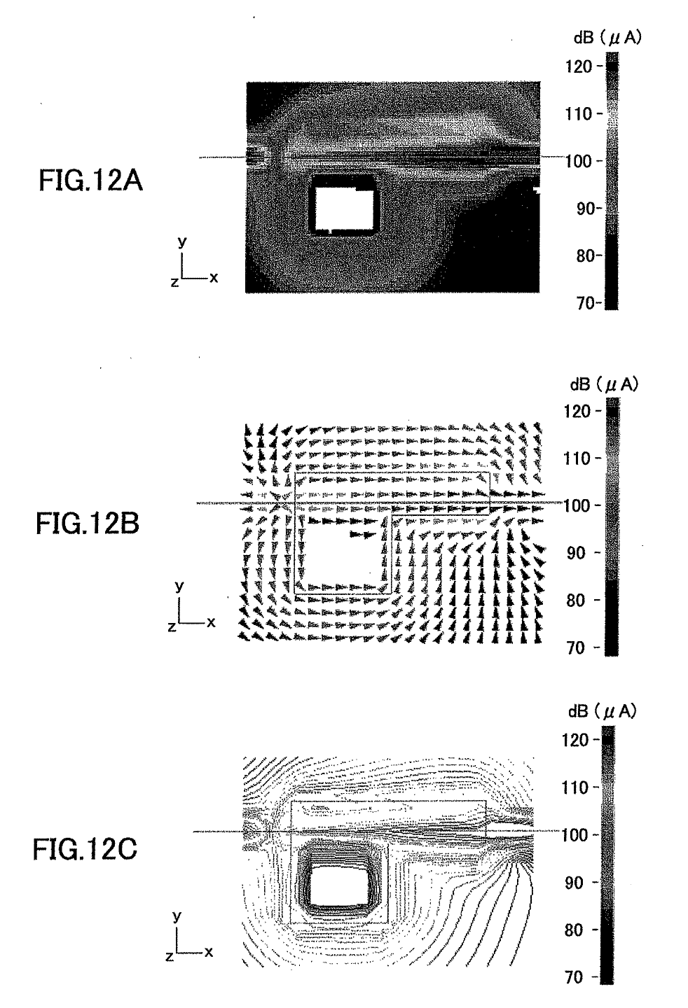

FIGS. 12A through 12C illustrate comparative examples of displayed electric current density distributions at a certain time point. FIG. 12A illustrates the electric current density distribution by gradations, FIG. 12B illustrates the electric current density distribution by cones of different densities, and FIG. 12C illustrates the electric current density distribution by contour lines.

The electric current density distribution illustrated in FIGS. 12A through 12C are formed by estimating positions where a skilled circuit designer assumes the electric current paths are located, analyzing the electric current density distribution at the positions by three-dimensional electromagnetic field analysis, and outputting the results of the analysis. Such an electric current density distribution of a certain time point is obtained for multiple time points, the temporal change in the electric current density distribution is identified by eyesight, and parts with large electric current density distributions are determined as the electric current paths.

Conventionally, the electric current density is expressed by gradations, cones or contour lines. However, the conventional technology only displays the electric current density at a certain time point. Thus, in cases where the electric current density changes significantly with the passage of time, the electric current density distribution needs to be calculated for multiple time points. Consequently, the data volume increases, which makes it difficult to perform the analysis efficiently.

Meanwhile, with the electromagnetic distribution processing device according to the present embodiment, as described above, the absolute values of the change amounts of the electric current density and the absolute values of the change amounts of the magnetic current density are accumulated in a temporal direction, and the electric current density distribution and the magnetic current density distribution are expressed by the cumulative values. Therefore, the electromagnetic distribution of signals are accurately and easily expressed by using a small amount of data, without the need of using different sets of electric current densities and magnetic current densities corresponding to multiple time points.

Furthermore, the data expressing temporal changes in the electromagnetic distribution is not used for displaying the electromagnetic distribution. Therefore, a small amount of data is used for displaying the electromagnetic distribution. Accordingly, it is possible to calculate the electromagnetic distribution for all areas on the printed circuit board. Thus, the electromagnetic distribution is efficiently and accurately identified without depending on the intuition of a skilled circuit designer. Hence, a high density, compact, high performance electronic device may be easily designed.

Accordingly, the electromagnetic distribution may be calculated for all of the transmission paths formed on the printed circuit board, without taking extensive time. Consequently, the TAT for analyzing the transmission paths is significantly reduced, thereby improving analysis efficiency.

Furthermore, as the data volume is small, the calculation results may be easily displayed within a short period of time.

Furthermore, a small memory capacity may be used for storing the data, and therefore the electromagnetic distribution processing device may be provided at a low price.

In FIGS. 11A and 11B, the electromagnetic distributions are displayed in black and white; however, the electromagnetic distributions may be displayed in color. When displaying in color, different colors may be used to display the different ranges, instead of using different dot densities as in FIGS. 11A and 11B.

Furthermore, in FIG. 11A, the differences between the cumulative values and the average value are segmented into percentage ranges, and FIG. 11B, the cumulative values of change amounts (absolute values) are segmented into value ranges. Different dot densities are used to display the respective ranges In both FIGS. 11A and 11B, the cumulative values of all ranges are displayed.

However, there may be a case of displaying only some of the ranges (for example, only the ranges of −20%˜+20% in FIG. 11A, or only the range of 2.0˜2.5 in FIG. 11B). In such a case, the condition creating unit 212 may create conditions of the ranges in accordance with input from the keyboard 13, and the calculation result display unit 219 may display the ranges in accordance with the created conditions. The condition creating unit 212 may also set a particular width for each range according to input from the keyboard 13.

In the above description, the electric current density or the magnetic current density is used as the physical amount of the electromagnetic current. However, the physical amount of the electromagnetic current is not limited to the electric current density or the magnetic current density, as long as the electric current distribution or the magnetic current distribution is expressed by a cumulative value of temporal changes.

Furthermore, in the above description, the FDTD method is used for calculating the electromagnetic field. However, the method of calculating the electromagnetic field is not limited to FDTD. The electromagnetic field may be calculated by any method as long as the temporal change amount of the electromagnetic field is derived. For example, the moment method may be performed to calculate the temporal change amount of the electromagnetic field.

According to an aspect of the present invention, an electromagnetic current distribution processing device, an electromagnetic current distribution processing method, and a computer-readable recording medium are provided, which are capable of calculating the cumulative value of temporal change amounts of the electromagnetic distribution, and calculating analysis results that accurately express transmission paths of signals, by using a small amount of data.

The present invention is not limited to the specific embodiments of the electromagnetic current distribution processing device, the electromagnetic current distribution processing method, and the electromagnetic current distribution processing program described herein, and variations and modifications may be made without departing from the scope of the present invention.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An electromagnetic distribution processing device for calculating an electromagnetic distribution over areas that are spatially discretized, the electromagnetic distribution processing device comprising:
an electromagnetic processing unit configured to calculate a physical amount of an electromagnetic current in each of the areas based on an electromagnetic field intensity;
an electromagnetic change amount processing unit configured to calculate, for each of the areas, a temporal change amount of the physical amount of the electromagnetic current calculated by the electromagnetic processing unit; and
a cumulative change amount processing unit configured to calculate, for each of the areas, a cumulative value that is obtained by accumulating the temporal change amounts of the physical amount of the electromagnetic current calculated by the electromagnetic change amount processing unit.

2. The electromagnetic distribution processing device according to claim 1, further comprising:
a database configured to store data used for calculating the cumulative value; and
a data management unit configured to manage an operation of storing the data into the database, wherein
the data management unit stores the cumulative value into the database when the electromagnetic processing unit has calculated the physical amount of the electromagnetic current in one of the areas, the electromagnetic change amount processing unit has calculated the temporal change amount of the physical amount of the electromagnetic current for the one of the areas, and the cumulative change amount processing unit has accumulated the temporal change amounts of the physical amount of the electromagnetic current for the one of the areas.

3. The electromagnetic distribution processing device according to claim 1, wherein
the cumulative change amount processing unit calculates the cumulative value of absolute values of the temporal change amounts of the physical amount of the electromagnetic current.

4. The electromagnetic distribution processing device according to claim 1, further comprising:
an average value calculating unit configured to calculate an average value of the cumulative values calculated by the cumulative change amount processing unit for the areas included in a predetermined space.

5. The electromagnetic distribution processing device according to claim 4, wherein
the average value calculating unit calculates the average value with the use of the cumulative values within a predetermined standard deviation or within a predetermined lower limit threshold and a predetermined upper limit threshold, among the cumulative values calculated for the areas by the cumulative change amount processing unit.

6. The electromagnetic distribution processing device according to claim 1, further comprising:
a display unit configured to display a processing result obtained by the cumulative change amount processing unit, wherein the processing result is obtained based on the cumulative values.

7. The electromagnetic distribution processing device according to claim 6, wherein
the display unit displays the areas in a different manner according to the cumulative values.

8. The electromagnetic distribution processing device according to claim 1, wherein
the electromagnetic change amount processing unit calculates the temporal change amount at predetermined time intervals.

9. The electromagnetic distribution processing device according to claim 1, wherein
the cumulative change amount processing unit calculates the cumulative value for predetermined ones of the areas.

10. The electromagnetic distribution processing device according to claim 1, wherein
the cumulative change amount processing unit calculates the cumulative value by accumulating the temporal change amounts within a predetermined period of time.

11. An electromagnetic distribution processing method executed by a computer for calculating an electromagnetic distribution over areas that are spatially discretized, the electromagnetic distribution processing method comprising:
calculating a physical amount of an electromagnetic current in each of the areas based on an electromagnetic field intensity;
calculating, for each of the areas, a temporal change amount of the physical amount of the electromagnetic current calculated at the calculating of the physical amount; and
calculating, for each of the areas, a cumulative value that is obtained by accumulating the temporal change amounts of the physical amount of the electromagnetic current calculated at the calculating of the temporal change amount.

12. A computer-readable recording medium recording an electromagnetic distribution processing program that causes a computer to execute a process of calculating an electromagnetic distribution over areas that are spatially discretized, the process comprising:
calculating a physical amount of an electromagnetic current in each of the areas based on an electromagnetic field intensity;
calculating, for each of the areas, a temporal change amount of the physical amount of the electromagnetic current calculated at the calculating of the physical amount; and
calculating, for each of the areas, a cumulative value that is obtained by accumulating the temporal change amounts of the physical amount of the electromagnetic current calculated at the calculating of the temporal change amount.
